(19) United States
(12) Patent Application Publication
(10) Pub. No.: US 2020/0377805 A1
(43) Pub. Date: Dec. 3, 2020

(54) METHODS AND SYSTEMS FOR REMOVING GAS CONTAMINANTS FROM FLOWING SOLIDS

(71) Applicant: ExxonMobil Research and Engineering Company, Annandale, NJ (US)

(72) Inventors: Matthew S. Mettler, Tomball, TX (US); Joseph S. Famolaro, Spring, TX (US); Masaaki Sugita, The Woodlands, TX (US); William S. Holloway, Beaumont, TX (US); Chris J. Wolfe, Beaumont, TX (US)

(21) Appl. No.: 16/860,957

(22) Filed: Apr. 28, 2020

Related U.S. Application Data
(60) Provisional application No. 62/856,279, filed on Jun. 3, 2019.

(51) Int. Cl. C10G 55/06; B01J 38/12; B01J 38/06; B01D 21/26; B01D 3/14; B01J 8/18; B01J 8/24; B01J 8/00

(52) U.S. Cl. CPC C10G 55/06; B01J 38/12; B01J 38/06; B01D 21/267; B01D 3/143; B01J 2208/00761; B01J 8/24; B01J 8/0025; C10G 2300/706; B01J 2208/00752; B01J 8/1827

(57) ABSTRACT

A method for removing gas contaminants from flowing solids in a fluid catalytic cracking (FCC) process can include: catalytically cracking a hydrocarbon feedstock in the presence of a catalyst in a riser of a FCC unit to produce a hydrocarbon product; separating the hydrocarbon product from a spent catalyst to produce a hydrocarbon product stream; regenerating the spent catalyst in a regeneration gas comprising oxygen to produce a mixture comprising a regenerated catalyst and a gas contaminant at a first concentration; introducing a stripping gas and the mixture into a regenerated catalyst stripper to produce a regenerated catalyst stream comprising the regenerated catalyst, the stripping gas, and a gas contaminant at a second concentration that is reduced by 50% or greater as compared to the first concentration; and introducing the regenerated catalyst stream to the riser.

### CROSS REFRENCE TO RELATED APPLICATIONS

This application claims the benefit of U.S. Provisional Application No. 62/856,279, filed on Jun. 3, 2019, the entire contents of which are incorporated herein by reference.

### BACKGROUND OF THE INVENTION

The present disclosure relates to economic and efficient operation of fluid catalytic cracking (FCC) units.

FCC has been, and will remain for quite some time, the primary conversion process in oil refining. In a typical present-day FCC process, a liquid feed mixture is atomized through a nozzle to form small droplets at the bottom of a riser. The droplets contact hot regenerated catalyst and are vaporized and cracked to lighter products and coke. The vaporized products rise through the riser. The catalyst is separated out from the hydrocarbon product stream through cyclones. Once separated, the catalyst is fed to a regenerator where coke is burned off with air. The catalyst, once regenerated, is then fed back into the riser along with the entrained gases and byproducts of the catalyst regeneration (e.g., N₂, CO, CO₂, SO₂, SO₃, NO, NO₂, O₂, CN, and low molecular weight cyanides). The riser-regenerator assembly is heat balanced in that heat generated by the coke burn is used for feed vaporization and cracking. As used herein, the term “low molecular weight cyanides” refers to a compound comprising one or more cyanide moieties and having a total molecular weight of 500 g/mol or less.

The hydrocarbon product stream includes hydrocarbon product entrained with the inert gasses and byproducts of the catalyst regeneration in air. The hydrocarbon product is fractionated into several product streams. One of these product streams is a light hydrocarbon stream that comprises light hydrocarbons (e.g., C₄₋ hydrocarbons) and gas contaminants like N₂, CO, CO₂, SO₂, SO₃, NO, NO₂, O₂, CN, and low molecular weight cyanides. To make the light hydrocarbons stream a more useful product the gas contaminants should be removed. This is done through a series of wet gas compression steps (e.g., often a dozen or more steps) that concentrate and extract these gas contaminants from the light hydrocarbons. This light hydrocarbons purification process typically has a set volume throughput, so the more gas contaminants that need to be removed, the more time the light hydrocarbons stream spends in the purification process. Accordingly, the light hydrocarbons purification process can be a rate-limiting step to the entire FCC process.

Further, depending on the conditions of the FCC process, the concentrations of corrosive cyanides in the hydrocarbon product can be an issue. For example, in partial burn FCC process, if a sufficient water wash is not used, the cyanides can become corrosive to the fractionation and other downstream equipment.

Accordingly, systems and methods that reduce the burden of gas contaminants like N₂, CO, CO₂, SO₂, SO₃, NO, NO₂, O₂, CN, and low molecular weight cyanides in the hydrocarbon product stream.

### SUMMARY

The present disclosure relates to economic and efficient operation of fluid catalytic cracking (FCC) units. More specifically, the present disclosure describes methods and systems that reduce the concentration of gases such as N₂, CO, CO₂, SO₂, SO₃, NO, NO₂, O₂, CN, and low molecular weight cyanides in the hydrocarbon product stream. This is achieved by inserting a stripping component between a catalyst regeneration unit and a feed zone of the FCC reactor.

For example, an embodiment of the present disclosure is a method comprising: catalytically cracking a hydrocarbon feedstock in the presence of a catalyst in a riser of a FCC unit to produce a hydrocarbon product; separating the hydrocarbon product from a spent catalyst to produce a hydrocarbon product stream; regenerating the spent catalyst in a regeneration gas comprising oxygen to produce a mixture comprising a regenerated catalyst and a gas contaminant (e.g., N₂, CO, CO₂, SO₂, SO₃, NO, NO₂, O₂, CN, a low molecular weight cyanide) at a first concentration; introducing a stripping gas (e.g., steam, N₂, CO₂, He, Ar) and the mixture into a regenerated catalyst stripper to produce a regenerated catalyst stream comprising the regenerated catalyst, the stripping gas, and a gas contaminant at a second concentration that is reduced by 50% or greater as compared to the first concentration; and introducing the regenerated catalyst stream to the riser.

In another example, an embodiment of the present disclosure is a riser fluidly coupled to a hydrocarbon feed source and configured to receive a hydrocarbon feed from the hydrocarbon feed source; a reactor fluidly coupled to the riser and configured to receive a mixture comprising a FCC hydrocarbon product and a catalyst from the riser; a separator fluidly coupled to the reactor and configured to separate the mixture into a hydrocarbon product stream and a spent catalyst stream; a regenerator fluidly coupled to the separator, configured to receive the spent catalyst stream from the separator, and configured to regenerate the spent catalyst to a regenerated catalyst to produce a regenerated catalyst stream; a regenerated catalyst stripper fluidly coupled to the regenerator, configured to receive the regenerated catalyst from the regenerator, and configured to strip gas contaminants (e.g., N₂, CO, CO₂, SO₂, SO₃, NO, NO₂, O₂, CN, a low molecular weight cyanide) from the regenerated catalyst stream with a stripping gas (e.g., steam, N₂, CO₂, He, Ar) to produce a catalyst stream, wherein the gas contaminant; and wherein the riser is fluidly coupled to the regenerated catalyst stripper and configured to receive the catalyst stream from the regenerated catalyst stripper.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 shows a FCC unit with a regenerated catalyst stripping component of the present disclosure located between a catalyst regeneration unit and a riser.

FIG. 2 illustrates a FCC unit that includes a counter current regenerated catalyst stripper.

FIG. 3 illustrates a FCC unit that includes a divided wall regenerated catalyst stripper.

### DETAILED DESCRIPTION

The present disclosure relates to economic and efficient operation of FCC units. More specifically, the present disclosure describes methods and systems that reduce the concentration of gases like N₂, CO, CO₂, SO₂, SO₃, NO, NO₂, O₂, CN, and low molecular weight cyanides in the hydrocarbon product stream. This is achieved by inserting a regenerated catalyst stripping component between a catalyst regeneration unit and a feed zone of the FCC reactor. A stripping gas used in the regenerated catalyst stripper should inert in the FCC reaction. Without being limited by theory, it is believed that the stripping gas will replace at least a portion of the gas contaminants. This allows for reducing the concentration of unwanted gas contaminants like N₂, CO, CO₂, SO₂, SO₃, NO, NO₂, O₂, CN, and low molecular weight cyanides in the hydrocarbon product stream. Examples of stripping gases include, but are not limited to, N₂, CO₂, He, Ar, steam, and the like, and any combination thereof. If N₂ and/or CO₂, are an unwanted gas contaminants, the stripping gas should comprise little to no N₂ and/or CO₂.

Optionally, the stripping gas can comprise gases that are readily condensable like steam. Accordingly, when using a stripping gas that includes readily condensable components, the hydrocarbon product stream will contain a lower concentration of gas contaminants that burden the downstream light hydrocarbon purification processes. Because the light hydrocarbon purification process can be a rate-limiting step to the entire FCC process, the overall FCC process may be performed at higher rates and/or higher yield of light hydrocarbons because of the process time relief the present disclosure provides on the light hydrocarbons purification process.

Gases that are readily condensable preferably have a boiling point less than about 100° C., or about −50° C. to about 100° C., or about −50° C. to about 50° C., or about −10° C. to about 100° C., or about 20° C. to about 100° C.

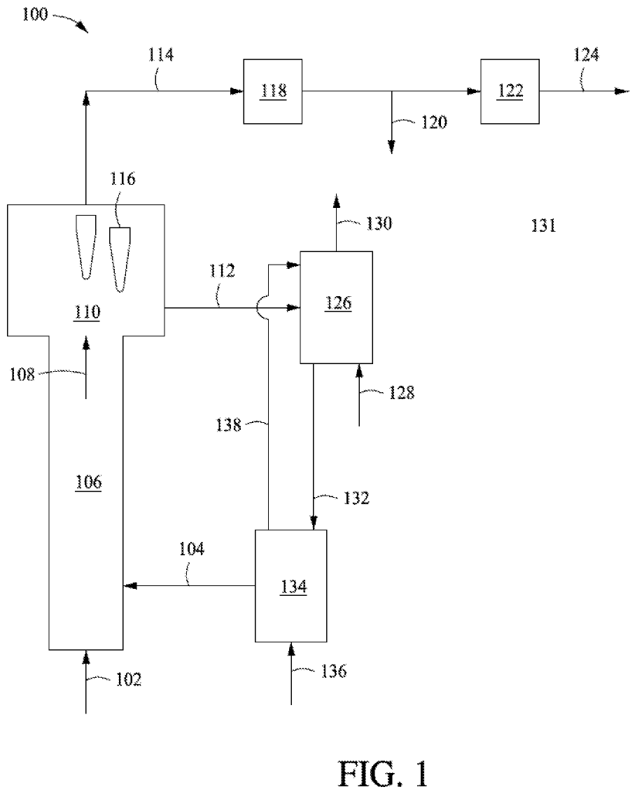

FIG. 1 shows a FCC system 100 with a regenerated catalyst stripping component of the present disclosure located between a catalyst regenerator 126 and a riser 106. In the FCC process, a liquid feed mixture 102 (e.g., a vacuum gas oil or residual fraction), typically preheated, and a regenerated catalyst 104 is fed into and contact each other in a riser 106. In the riser 106, the hydrocarbon of the liquid feed mixture 102 is cracked to produce a mixture 108 comprising catalyst, hydrocarbon product, and unconverted hydrocarbon. The mixture 108 then enters a disengaging zone 110 (also referred to as a reactor) in which spent catalyst 112 is separated from the hydrocarbon product 114 with, for example, cyclones 116 or other inertial devices.

The hydrocarbon product 114 are then processed by traditional methods include distillation in a main fractionator column 118, condensation and removal of water 120, and wet gas compression 122 to separate gas contaminants (e.g., gas products and unreacted air from the regeneration reaction and other gas contaminants) from the light ends 124 of the hydrocarbon product. These gas contaminants can include, but are not limited to, N₂, CO, CO₂, SO₂, SO₃, NO, NO₂, O₂, CN, low molecular weight cyanides, and the like, and combinations thereof. As described previously, the wet gas compression 120 that purifies the light hydrocarbons 124 is a rate-limiting step to FCC process.

From the cyclones 116, the separated, spent catalyst 112 is then sent to a regenerator 126 where the carbon (also referred to as coke) accumulated on the catalyst is oxidatively combusted with a regeneration gas 128 comprising oxygen (e.g., air, oxygen-enriched air, and the like) to reactivate the catalyst and to supply the heat for the endothermic cracking reactions. This process produces a flue gas 130 and a mixture 132 comprising the hot, regenerated catalyst and gas from the regenerator 126. The gas in the mixture 132 is primarily composed of gas products and unreacted regeneration gas from the regeneration reaction and other gas contaminants. In a current FCC process, the mixture 132 would be recycled directly into the riser 106. In the present disclosure, to reduce the concentration of gas contaminants that are entrained with the light hydrocarbons before wet gas compression 120, a stripping process is performed on the mixture 132 from the regenerator 126. That is, the mixture 132 from the regenerator 126 is conveyed to a regenerated catalyst stripper 134 that has a counter-flow of a stripping gas 136. As a result, the stripping gas 136 replaces at least some of the gas contaminants in the mixture 132. As a result, the regenerated catalyst stripper 134 has gas contaminants 138 effluent and regenerated catalyst 104 effluent. The regenerated catalyst 104 is recycled back into the riser 106 for further cracking reaction.

The concentration of one or more individual gas contaminants (e.g., N₂, CO, CO₂, SO₂, SO₃, NO, NO₂, O₂, CN, and low molecular weight cyanides) may be reduced by 50% or greater (e.g., 50% to 95%, or 50% to 75%, or 60% to 80%, or 75% to 95%) when comparing the gas contaminant concentration (wt %) in the mixture 132 ([X_{M}]) to the gas contaminant concentration (wt %) in the catalyst stream 104 ([X_{C}]), which is calculated as ([X_{M}]−[X_{C}])/[X_{M}]*100. As would be apparent to one skilled in the art, when using a stripping gas comprising N₂ and/or CO₂, changes in the N₂ and/or CO₂ concentration are not considered or limited by the foregoing. Consequently, the hydrocarbon product stream 114 can comprise gas contaminants like CO, SO₂, SO₃, NO, NO₂, O₂, CN, and low molecular weight cyanides cumulatively at less than 10 wt % of the gas phase, or 0 wt % to about 10 wt % of the gas phase, or 5 wt % to about 10 wt % of the gas phase, or 1 wt % to about 5 wt % of the gas phase, or 0 wt % to about 1 wt % of the gas phase. Such ranges may also apply to N₂ and/or CO₂ when the stripping gas does not comprise N₂ and/or CO₂ or comprises N₂ and/or CO₂ at a sufficiently low concentration.

The gas contaminants 138 are recycled back into the regenerator 126 where unreacted oxygen can be used in the regeneration reaction and at least a portion of the gas contaminants 138 entrains in the flue gas 130. As illustrated, the gas contaminants 138 are recycled back into the regenerator 126 at a location above where the spent catalyst 112 enters the regenerator 126. This may advantageously allow for more of the gas contaminants 138 to entrain with the flue gas 130 rather than cycle back through as part of the mixture 132. However, the methods and systems of the present disclosure are not limited by the location of gas contaminants 138 being introduced to the regenerator 126.

Accordingly, a system of the present disclosure can include: a riser 106 fluidly coupled to a hydrocarbon feed source (not illustrated) and configured to receive a hydrocarbon feed 102 from the hydrocarbon feed source; a reactor 110 fluidly coupled to the riser 106 and configured to receive a mixture comprising a FCC hydrocarbon product and a catalyst from the riser 106; a separator 116 fluidly coupled to the reactor 110 and configured to separate the mixture into a hydrocarbon product stream 114 and a spent catalyst stream 112; a regenerator 126 fluidly coupled to the separator 116, configured to receive the spent catalyst stream 112 from the separator 116, and configured to regenerate the spent catalyst to a regenerated catalyst to produce a regenerated catalyst stream 132; a regenerated catalyst stripper 134 fluidly coupled to the separator 116, configured to receive the regenerated catalyst from the regenerator 126, and configured to strip gas contaminants from the regenerated catalyst stream 132 with a stripping gas to produce a catalyst stream 104, wherein the gas contaminant comprises one or more selected from the group consisting of N₂, CO, CO₂, SO₂, SO₃, NO, NO₂, O₂, CN, low molecular weight cyanides, and other potential contaminants; and wherein the riser 106 is fluidly coupled to a regenerated catalyst stripper 134 and configured to receive the catalyst stream 104 from the regenerated catalyst stripper 134. The system can further include a preheater (not illustrated) fluidly coupled to the regenerated catalyst stripper 134, configured to preheat the stripping gas 136, and configured to supply the stripping gas 136 to the regenerated catalyst stripper 134. The system can further include processing components for the hydrocarbon product stream (e.g., a main fractionator column 118, a condenser condensation and removal of water and/or stripping gas 120, and wet gas compression components 122 to remove gas contaminants from the light ends 124 of the hydrocarbon product). The regenerated catalyst stripper 134 can be further configured to produce a gas contaminants stream 138, fluidly coupled to the regenerator 126, and configured to supply the gas contaminants stream 138 to the regenerator 126.

Further, a method of the present disclosure can include: catalytically cracking a hydrocarbon feedstock 102 in the presence of a catalyst 104 in a riser 106 of a FCC unit 100 to produce a mixture 108 comprising a hydrocarbon product and the catalyst; separating the mixture into a hydrocarbon product stream and a catalyst stream; regenerating the catalyst in the catalyst stream 112 with a regeneration gas 128 comprising oxygen to produce a mixture 132 comprising regenerated catalyst and a gas contaminant at a first concentration, wherein the gas contaminant comprises one or more selected from the group consisting of CO, CO₂, SO₂, SO₃, NO, NO₂, O₂, CN, low molecular weight cyanides, and other potential contaminants; introducing a stripping gas and the mixture 132 into a regenerated catalyst stripper 134 to produce a regenerated catalyst stream 104 comprising the regenerated catalyst, the stripping gas, and a gas contaminant at a second concentration, wherein the second concentration is reduced by 50% or greater compared to the first concentration; and introducing the regenerated catalyst stream 104 to the riser 106. The hydrocarbon product stream 114 may comprise the hydrocarbon product and the gas contaminant at less than 10 wt % of a gas phase of the hydrocarbon product stream. The method can further comprise: preheating the stripping gas 136 to as high as 800° C. before introduction to the regenerated catalyst stripper 134. The method can also further comprise: producing a gas contaminants stream 138 from the regenerated catalyst stripper 134; and recycling the gas contaminants 138 from the regenerated catalyst stripper 134 to the regenerator 126.

In current FCC units that do not include the regenerated catalyst stripper 134, the location of the regenerator relative to the inlet of the regenerated catalyst to the riser and the angle of a line connecting them can be important depending on the design of the FCC unit. That is, these components can be configured in such a way that a downward angle of the line connecting the regenerator and the riser promote flow of the catalyst particles with minimal need for additional conveyance components. Accordingly, such design parameters should be considered when retrofitting such FCC units and the production of new FCC units that utilize the regenerated catalyst stripper described herein between the regenerator and the riser. That is, the type of regenerated catalyst stripper 134, the configuration of the inlets and outlets of the regenerated catalyst stripper 134, and the configuration of the corresponding lines can be designed to achieve the desired flow characteristics of the regenerated catalysts particles from the regenerator 126 through the regenerated catalyst stripper 134 to the riser 106.

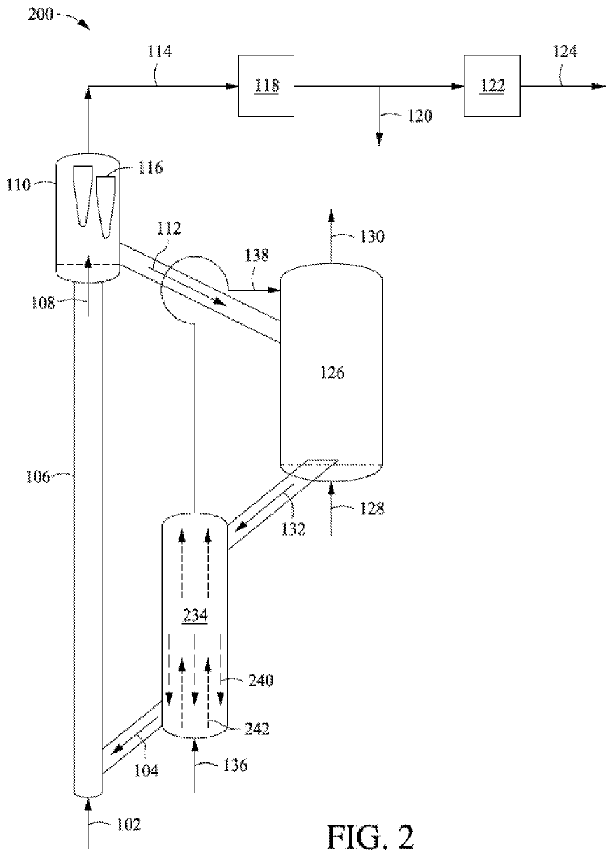

FIG. 2 illustrates a FCC unit 200 that includes a counter current regenerated catalyst stripper 234. FIG. 2 includes like numbered components to FIG. 1 and incorporates the corresponding description above. In this example, the mixture 132 comprising the hot, regenerated catalyst and gas flows from the regenerator 118 at a downward angle and enters the counter current regenerated catalyst stripper 234 along the side near the top of the counter current regenerated catalyst stripper 234. The stripping gas 136 flows into the bottom of the counter current regenerated catalyst stripper 234. In the counter current regenerated catalyst stripper 234, the stripping gas 136 replaces at least some of the gas contaminants in the mixture 132. A mixture 240 (long dashed arrows) comprising the catalyst and the stripping gas flow to the bottom, while the gas contaminants and a portion of the stripping gas flow upward as mixture 242 (short dashed arrows). Accordingly, the regenerated catalyst 104 has primarily stripping gas as the carrier gas as it flows again at a downward angle from the bottom of the counter current regenerated catalyst stripper 234 to the bottom of the riser 106.

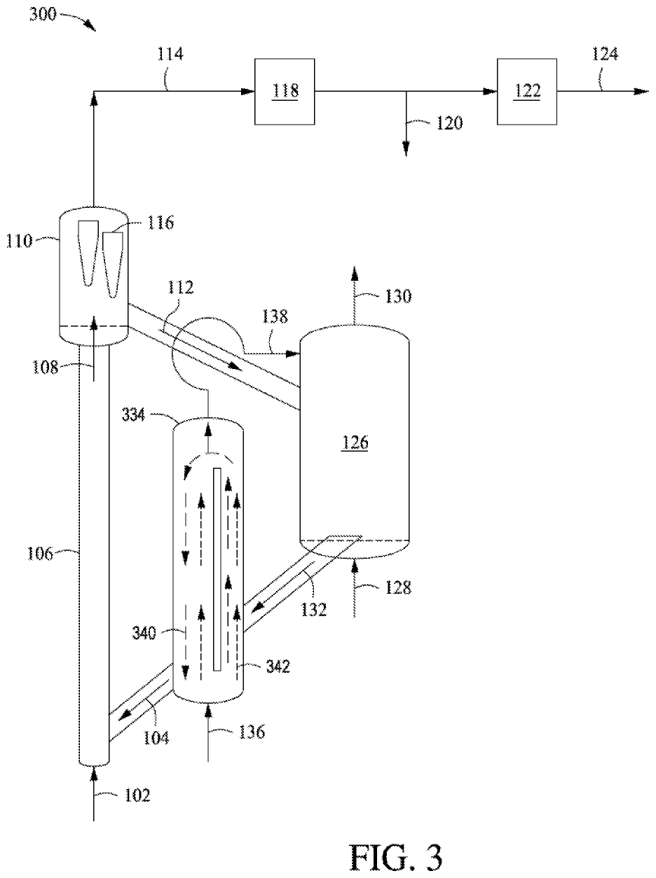

FIG. 3 illustrates a FCC unit 300 that includes a divided wall regenerated catalyst stripper 334. FIG. 3 includes like numbered components to FIG. 1 and incorporates the corresponding description above. In this example, the mixture 132 comprising the hot, regenerated catalyst and gas flows from the regenerator 118 at a downward angle and enters the divided wall regenerated catalyst stripper 334 along the side near the middle to bottom of the divided wall regenerated catalyst stripper 334. The stripping gas 136 flows into the bottom of the divided wall regenerated catalyst stripper 334. In the divided wall regenerated catalyst stripper 334, the stripping gas 136 replaces at least some of the gas contaminants in the mixture 132. A mixture 340 (long dashed arrows) comprising the catalyst and the stripping gas flows up and over the wall eventually to the bottom, while the gas contaminants and a portion of the stripping gas flow upward as mixture 342 (short dashed arrows). Accordingly, the regenerated catalyst 104 has primarily stripping gas as the carrier gas as it flows again at a downward angle from the bottom of the divided wall regenerated catalyst stripper 334 to the bottom of the riser 106.

The two foregoing are considered nonlimiting examples. Other configurations of strippers can be used between the regenerator and the riser.

The FCC units and methods described herein can be any FCC unit adapted to have a regenerated catalyst stripper between the regenerator and the riser. Examples of FCC units and methods can include these described in US Pat. Appl. Pub. Nos. 2001/0032802, 2001/0032803, 2001/0040118, 2006/0231458, 2007/0051665, 2007/0251863, 2011/0132806, and 2013/0165717, each of which are incorporated herein by reference.

In the FCC units described herein, the hydrocarbon feed is preferably a petroleum gasoil having an ASTM boiling point above 150° C., or 150° C. to 565+° C., or 220° C. to 340° C., or 340° C. to 565° C., or 565+° C. However, heavy residuum can also be present in the feedstock.

A reaction zone in the riser may be maintained at cracking conditions typically above about 425° C. (e.g., about 425° C. to about 650° C., or about 480° C. to about 650° C.) and a pressure of from about 65 kPa to 500 kPa.

A weight ratio of catalyst to hydrocarbon feed, based on the weight of each entering the bottom of the riser, may range up to 20:1 but is preferably between about 4:1 and about 10:1.

An average residence time of catalyst in the riser is preferably less than about 5 seconds.

The type of catalyst employed in the process may be chosen from a variety of commercially available catalysts, preferably having a zeolitic component material.

The regenerator may be operated at a temperature up to about 800° C. (e.g., about 50° C. to about 800° C., or about 50° C. to about 150° C., or about 100° C. to about 250° C., or about 200° C. to about 500° C., or about 500° C. to about 800° C.) and a pressure of from about 35 kPa to 500 kPa (e.g., about 35 kPa to about 150 kPa, or about 100 kPa to about 250 kPa, or about 200 kPa to about 450 kPa, or about 250 kPa to about 500 kPa).

The regenerated catalyst stripper may be operated at a temperature up to about 800° C. (e.g., about 50° C. to about 800° C., or about 50° C. to about 150° C., or about 100° C. to about 250° C., or about 200° C. to about 500° C., or about 500° C. to about 800° C.) and a pressure of from about 35 kPa to 500 kPa (e.g., about 35 kPa to about 150 kPa, or about 100 kPa to about 250 kPa, or about 200 kPa to about 450 kPa, or about 250 kPa to about 500 kPa).

The stripping gas introduced to the regenerated catalyst stripper may be preheated to a temperature as high as about 800° C. (e.g., about 50° C. to about 800° C., or about 50° C. to about 150° C., or about 100° C. to about 250° C., or about 200° C. to about 500° C., or about 500° C. to about 800° C.).

### Example Embodiments

A first nonlimiting example embodiment is a method comprising: catalytically cracking a hydrocarbon feedstock in the presence of a catalyst in a riser of a FCC unit to produce a hydrocarbon product; separating the hydrocarbon product from a spent catalyst to produce a hydrocarbon product stream; regenerating the spent catalyst in a regeneration gas comprising oxygen to produce a mixture comprising a regenerated catalyst and a gas contaminant at a first concentration; introducing a stripping gas and the mixture into a regenerated catalyst stripper to produce a regenerated catalyst stream comprising the regenerated catalyst, the stripping gas, and a gas contaminant at a second concentration that is reduced by 50% or greater as compared to the first concentration; and introducing the regenerated catalyst stream to the riser. The first example embodiment may further include one or more of the following: Element 1: wherein the wherein the gas contaminant comprise N₂, CO, CO₂, SO₂, SO₃, NO, NO₂, O₂, CN, or a low molecular weight cyanide; Element 2: wherein the hydrocarbon product stream comprises the hydrocarbon product and the gas contaminant at less than 5 wt % of a gas phase of the hydrocarbon product stream; Element 3: wherein the stripping gas is inert in the catalytic cracking and comprises a component that condenses at 100° C. or less; Element 4: wherein the stripping gas comprises steam; Element 5: wherein the stripping gas comprises N₂, CO₂, He, and/or Ar; and wherein the gas contaminant and the stripping gas are different; Element 6: the method further comprising: preheating the stripping gas is preheated to up to about 800° C. before introduction to the regenerated catalyst stripper; Element 7: wherein the regenerated catalyst stripper is a counter current regenerated catalyst stripper; Element 8: wherein the regenerated catalyst stripper is a divided wall regenerated catalyst stripper; Element 9: the method further comprising: producing a gas contaminants stream from the regenerated catalyst stripper; and recycling the gas contaminants stream back to a regenerator where regenerating the catalyst occurs; Element 10: wherein regenerating the catalyst is at about 600° C. to about 800° C. and at about 35 kPa to 500 kPa; and Element 11: wherein the regenerated catalyst stripper is operated at about 600° C. to about 800° C. and about 35 kPa to 500 kPa. Examples of combinations include, but are not limited to, Element 1 in combination with one or more of Elements 2-11; Element 2 in combination with one or more of Elements 3-11; one of Elements 3-5 in combination with one or more of Elements 6-11; Element 6 in combination with one or more of Elements 7-11; Element 7 or 8 in combination with one or more of Elements 9-11; and two or more of Elements 9-11 in combination.

A second nonlimiting example embodiment is a riser fluidly coupled to a hydrocarbon feed source and configured to receive a hydrocarbon feed from the hydrocarbon feed source; a reactor fluidly coupled to the riser and configured to receive a mixture comprising a FCC hydrocarbon product and a catalyst from the riser; a separator fluidly couple to the reactor and configured to separate the mixture into a hydrocarbon product stream and a spent catalyst stream; a regenerator fluidly coupled to the separator, configured to receive the spent catalyst stream from the separator, and configured to regenerate the spent catalyst to a regenerated catalyst to produce a regenerated catalyst stream; a regenerated catalyst stripper fluidly coupled to the regenerator, configured to receive the regenerated catalyst from the regenerator, and configured to strip gas contaminants from the regenerated catalyst stream with a stripping gas to produce a catalyst stream, wherein the gas contaminant; and wherein the riser is fluidly coupled to the regenerated catalyst stripper and configured to receive the catalyst stream from the regenerated catalyst stripper. The second example embodiment may further include one or more of the following: Element 1; Element 3; Element 4; Element 5; Element 7; Element 8; Element 12: the system further comprising: a preheater fluidly coupled to the regenerated catalyst stripper, configured to preheat the stripping gas, and configured to supply the stripping gas to the regenerated catalyst stripper; and Element 13: wherein the regenerated catalyst stripper is configured to produce a gas contaminants stream, is fluidly coupled to the regenerator, and configured to supply the gas contaminants stream to the regenerator. Examples of combinations include, but are not limited to, Element 1 in combination with one of Elements 3-5 and optionally in further combination with one or more of Elements 7, 8, 12, or 13; Element 1 in combination with one or more of Elements 7, 8, 12, or 13; one of Elements 3-5 in combination with one or more of Elements 7, 8, 12, or 13; Element or 8 in combination with Element 12 and/or Element 13; and Elements 12 and 13 in combination.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
catalytically cracking a hydrocarbon feedstock in the presence of a catalyst in a riser of a fluid catalytic cracking (FCC) unit to produce a hydrocarbon product;
separating the hydrocarbon product from a spent catalyst to produce a hydrocarbon product stream;
regenerating the spent catalyst in a regeneration gas comprising oxygen to produce a mixture comprising a regenerated catalyst and a gas contaminant at a first concentration;
introducing a stripping gas and the mixture into a regenerated catalyst stripper to produce a regenerated catalyst stream comprising the regenerated catalyst, the stripping gas, and a gas contaminant at a second concentration that is reduced by 50% or greater as compared to the first concentration; and
introducing the regenerated catalyst stream to the riser.

2. The method of claim 1, wherein the wherein the gas contaminant comprise N₂, CO, CO₂, SO₂, SO₃, NO, NO₂, O₂, CN, or a low molecular weight cyanide.

3. The method of claim 1, wherein the hydrocarbon product stream comprises the hydrocarbon product and the gas contaminant at less than 5 wt % of a gas phase of the hydrocarbon product stream.

4. The method of claim 1, wherein the stripping gas is inert in the catalytic cracking and comprises a component that condenses at 100° C. or less.

5. The method of claim 1, wherein the stripping gas comprises steam.

6. The method of claim 1, wherein the stripping gas comprises N₂, CO₂, He, and/or Ar; and
wherein the gas contaminant and the stripping gas are different.

7. The method of claim 1, further comprising:
preheating the stripping gas is preheated to up to about 800° C. before introduction to the regenerated catalyst stripper.

8. The method of claim 1, wherein the regenerated catalyst stripper is a counter current regenerated catalyst stripper.

9. The method of claim 1, wherein the regenerated catalyst stripper is a divided wall regenerated catalyst stripper.

10. The method of claim 1, further comprising:
producing a gas contaminants stream from the regenerated catalyst stripper; and
recycling the gas contaminants stream back to a regenerator where regenerating the catalyst occurs.

11. The method of claim 1, wherein regenerating the catalyst is at about 600° C. to about 800° C. and at about 35 kPa to 500 kPa.

12. The method of claim 1, wherein the regenerated catalyst stripper is operated at about 600° C. to about 800° C. and about 35 kPa to 500 kPa.

13. A system comprising:
a riser fluidly coupled to a hydrocarbon feed source and configured to receive a hydrocarbon feed from the hydrocarbon feed source;
a reactor fluidly coupled to the riser and configured to receive a mixture comprising a fluid catalytic cracking (FCC) hydrocarbon product and a catalyst from the riser;
a separator fluidly couple to the reactor and configured to separate the mixture into a hydrocarbon product stream and a spent catalyst stream;
a regenerator fluidly coupled to the separator, configured to receive the spent catalyst stream from the separator, and configured to regenerate the spent catalyst to a regenerated catalyst to produce a regenerated catalyst stream;
a regenerated catalyst stripper fluidly coupled to the regenerator, configured to receive the regenerated catalyst from the regenerator, and configured to strip gas contaminants from the regenerated catalyst stream with a stripping gas to produce a catalyst stream, wherein the gas contaminant; and
wherein the riser is fluidly coupled to the regenerated catalyst stripper and configured to receive the catalyst stream from the regenerated catalyst stripper.

14. The system of claim 13, wherein the wherein the gas contaminant comprise N₂, CO, CO₂, SO₂, SO₃, NO, NO₂, O₂, CN, or a low molecular weight cyanide.

15. The system of claim 13, wherein the stripping gas is inert in a catalytic cracking reaction and comprises a component that condenses at 100° C. or less.

16. The system of claim 13, wherein the stripping gas comprises N₂, CO₂, He, and/or Ar; and
wherein the gas contaminant and the stripping gas are different.

17. The system of claims 13 further comprising:
a preheater fluidly coupled to the regenerated catalyst stripper, configured to preheat the stripping gas, and configured to supply the stripping gas to the regenerated catalyst stripper.

18. The system of claims 13, wherein the stripper is a counter current regenerated catalyst stripper.

19. The system of claim 13, wherein the stripper is a divided wall regenerated catalyst stripper.

20. The system of claim 13, wherein the regenerated catalyst stripper is configured to produce a gas contaminants stream, is fluidly coupled to the regenerator, and configured to supply the gas contaminants stream to the regenerator.
